(19) United States
(12) Patent Application Publication
(10) Pub. No.: US 2025/0105774 A1
(43) Pub. Date: Mar. 27, 2025

(54) Rotatable AI solar panel system for houses roof

(71) Applicant: Yongyang Qiu, Chino Hills, CA (US)

(72) Inventor: Yongyang Qiu, Chino Hills, CA (US)

(21) Appl. No.: 18/372,553

(22) Filed: Sep. 25, 2023

(51) Int. Cl. H02S 20/23; H02S 30/20

(52) U.S. Cl. CPC H02S 20/23; H02S 20/32; H02S 30/20

(57) ABSTRACT

This utility model relates to the field of solar energy technology and provides a rotatable roof solar system. It includes an installation bracket and a support plate, which are connected through hinges. It also includes two cylinders, which are movably connected to the inner wall of the installation bracket on opposite sides. By activating the cylinders and coordinating with the U-shaped block, the support plate can rotate upward around the hinges and remain in a horizontal position. When adjustment of the orientation of solar panel 1 and solar panel 2 is needed, the motor can be activated to drive the output shaft, which in turn drives the rotating rod and the rotating disk. This movement can rotate the support plate 2 and installation bracket 2, aligning solar panel 1 and solar panel 2 with the position of sunlight. This allows for prolonged exposure of solar panel 1 and solar panel 2 to sunlight, thereby improving the efficiency of converting solar energy into electricity.

### COPYRIGHT NOTICE

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever.

### BACKGROUND

### Field of the Invention

The present invention is related to a solar power device that is capable of performing the conversion of solar energy to electrical energy (photovoltaic principle), and in particular to an AI-based solar panel with various advancements and functionalities.

### Description of the Related Art

Due to increasing environmental concerns, alternatives to non-renewable and polluting fossil fuels are constantly being investigated. Solar energy has received increasing attention as an alternative renewable, non-polluting energy source, and photovoltaic installations, such as on commercial and residential roofs, are becoming increasingly popular. It is well known that solar power is derived from photovoltaic systems, solar panels made from silicon, and from other materials and thin film solar deployments. An array of solar panels tied together with one or more solar power gathering devices is an environmentally sustainable method of generating clean energy that can be used internationally. Solar power generation can come from thin film solar applications, panelized silicon crystal applications, and also from passive solar design schemes and many other sources. The cost of solar power gathering systems has decreased in recent years with efficiency improving. Traditional photovoltaic racking systems often require lengthy and complicated assembly and shipping methodologies, which may increase the need for specialized or costly tools or shipping requirements.

The conversion of solar energy to electrical energy through the use of systems such as photovoltaic cells, arrays, passive absorbers of solar energy, solar furnaces etc., is well established in the art. Systems have also been proposed to converting solar energy to electric energy; however, these systems employ apparatus which is complicated to fabricate, such as sealed outdoor laminated 36 solar cell enclosures.

For example, U.S. Pat. No. 4,080,221 describes a system for converting solar energy to electric energy, which employs a substantially sealed, weather tight enclosure for the solar collectors. U.S. Pat. No. 4,493,940 describes a solar collector on which photo voltaic cells are mounted with the assembly being surrounded by an enclosure that is sealed by a metal sealing collar, and U.S. Pat. No. 4,373,308 describes a flat plate solar collector in a spaced relationship to an array of photovoltaic cells.

There are multiple solutions that have been presented in prior art. However, these solutions are limited and restricted to their conventional systems. The current invention is focused on presenting an AI-based solar panel that provides various design advancements and functionalities.

None of the previous inventions and patents, taken either singly or in combination, is seen to describe the instant invention as claimed. Hence, the inventor of the present invention proposes to resolve and surmount existent technical difficulties to eliminate the aforementioned shortcomings of prior art.

### SUMMARY

In light of the disadvantages of the prior art, the following summary is provided to facilitate an understanding of some of the innovative features unique to the present invention and is not intended to be a full description. A full appreciation of the various aspects of the invention can be gained by taking the entire specification, claims, drawings, and abstract as a whole.

The primary desirable object of the present invention is to provide a novel and improved method for a reliable AI-based solar panel for a house's roof designed for converting solar energy to electrical energy.

It is also the primary objective of the invention to provide a smart solar panel whereby using AI-based approach, the panel can rotate 360 degrees towards the sun, thereby increasing the charging efficiency by more than 50% compared to traditional fixed solar systems.

It is another objective of the invention to provide a system where the proposed assembly allows the system to manage itself automatically without the human intervention needed.

It is also the object of the invention to provide an advanced system whereby a built-in camera to oversee the neighboring trees and detects motion. Furthermore, the AI system employs wind sensors to calculate wind velocity and can create precise weather predictions by utilizing its intelligent sensors and smart design.

It is also the object of the invention to provide an inbuilt camera that can evaluate the cleanliness of solar panels and compare their power production. In the event of dirty panels and no rain, the AI will promptly notify the appropriate personnel to clean them. Moreover, during the rainy season, the AI can automatically clean the panels. The solar panels are equipped with automated brushes that eliminate dust, and the AI diligently ensures their optimal performance by regularly cleaning them.

It is further the objective of the invention to provide a cutting-edge system that leverages AI to provide home security. In the case of single-story dwellings, the solar panel camera can double up as a surveillance camera for security purposes. For bigger homes that span over two, three, or more stories, additional cameras can be incorporated. By connecting to the home cameras via Wi-Fi, the AI can effectively monitor the property, detect faces, and assist in minimizing security costs.

It is moreover the objective of invention to mitigate wind resistance and bolster the safety of solar panels by implementing wind resistance attenuators and fasteners in their vicinity. During instances of high wind, these fasteners function to secure the panels in place and enable them to withstand the powerful force exerted upon them.

It is also the objective of the invention to provide an AI solar panel system that is installed inside the house, it can also detect fires and gas hazards in the house.

It is further objective of the invention to provide AI system that provides an artificial intelligence (AI) system that automates the monitoring of electricity usage, generates bills for users, and sends notifications. The system is designed to streamline the process of monitoring and billing for electricity usage, making it more efficient and cost-effective. By automating these processes, users can save time and money, while also reducing the potential for errors and inaccuracies. The system is ideal for businesses, academic institutions, and other organizations that rely heavily on electricity usage and need an accurate and reliable way to monitor and manage their energy consumption. With this AI-powered system, users can have greater control over their energy usage, while also reducing their carbon footprint.

It is further the objective to provide an AI system that automatically removes snow from the solar panels. When there is heavy snow, the panels tilt to 90 degrees, automatically removing the snow. In windy and snowy weather, the panels adjust the optimal charging based on wind speed. In rainy weather, the AI controls the panels to restore normal operation.

It is also the objective of the invention to provide a cost-effective, efficient, and self-cleaning system.

It is moreover the objective of the invention to provide systems, wherein the energy collected by the solar panel is converted into electrical energy, stored in a battery or converted into AC voltage through a converter, and connected to the grid for power generation.

Other aspects, advantages and novel features of the present invention will become apparent from the detailed description of the invention when considered in conjunction with the accompanying drawings.

This Summary is provided merely for purposes of summarizing some example embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a schematic diagram of the structure of a rotatable roof solar system provided by the present utility model;

FIG. 2 is a front view schematic diagram of a rotatable roof solar system provided by the present utility model;

FIG. 3 is a rear view schematic diagram of a rotatable roof solar system provided by the present utility model;

FIG. 4 is a schematic diagram of the structure of installation frame 1 provided by the present utility model;

FIG. 5 is a rear view schematic diagram of support plate 2 of a rotatable roof solar system provided by the present utility model;

FIG. 6 is a front view schematic diagram of support plate 2 of a rotatable roof solar system provided by the present utility model;

FIG. 7 is a schematic diagram of the structure of U-shaped bracket provided by the present utility model.

The apparatus and method components have been represented where appropriate by conventional symbols in the drawings, showing only those specific details.

### DETAILED DESCRIPTION

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

In the present utility model, a rotatable roof solar system is disclosed. The system includes an installation bracket and a support plate, which are connected by hinges. It further includes two cylinders, which are movably connected to the inner wall of the installation bracket on the opposite side. The bottom of the support plate is symmetrically fixed with two U-shaped blocks, and one end of each cylinder is movably embedded in the opposite side of the two arms of the U-shaped blocks.

In this way, the roof solar system can be rotated according to the change of sunlight, thereby improving the efficiency of converting solar energy into electricity. The system also prevents the accumulation of dirt, such as dust or bird droppings, on the solar panels. Additionally, the system can effectively remove snow from the solar panels, ensuring their normal use.

The rotatable roof solar system disclosed in the present utility model provides a flexible and efficient solution for utilizing solar energy.

In addition to the previously mentioned components, the described rotatable roof solar system further includes:
A rotating rod, which is movably embedded in the center of the support plate.
An electric motor is fixedly installed at the bottom of the support plate, and its output end is fixedly installed at one end of the rotating rod.
The other end of the rotating rod is fixedly installed with a rotating disc.
A second support plate is fixedly installed on the top of the rotating disc.
On one side of the second support plate, there is an installation bracket connected by hinges.
Inside the installation bracket, two solar panels (solar panel 2) are symmetrically movably embedded.
The top of the installation bracket is fixedly installed with a solar panel (solar panel 1).
Two U-shaped blocks are symmetrically fixedly installed at the bottom of the installation bracket.
On the opposite side of the second support plate, there are two cylinders movably embedded.
One end of each cylinder is movably embedded in the opposite side of the two arms of the U-shaped blocks.

Optionally, on the opposite side of the installation bracket, there are two symmetrically fixed L-shaped blocks. The L-shaped blocks are divided into two groups, and each group is fixedly installed with a frame on the opposite side. The inner wall of each frame is movably embedded with a movable block. On the opposite side of each movable block, a circular rod is fixedly embedded. The outer surface of the circular rod is fixedly sleeved with a cleaning strip. At both ends of the circular rod, there are movably sleeved connecting rods. On the opposite side of the second support plate, two fixed bars are symmetrically fixedly installed. One end of each connecting rod is movably sleeved on the outer surface of the supporting rod of each fixed bar.

Optionally, two slide grooves are symmetrically opened at the bottom of the installation bracket. Inside each slide groove, there is a movable slider. On one side of each movable slider, it is fixedly installed at the bottom of the solar panel 2 near the end. The bottom of the installation bracket is fixedly installed with a U-shaped frame. The center of the U-shaped frame is movably embedded with a rotating rod (rotating rod 2). One end of the rotating rod 2 is movably embedded in the bottom of the installation bracket. The outer surface of the installation bracket is fixedly sleeved with a movable strip (movable strip 1). At both ends of the movable strip 1, there are movably connected movable strips 2. One end of each movable strip 2 is movably connected to one side of each slider. The bottom of the U-shaped frame is fixedly installed with an electric motor (electric motor 2), and its output end is fixedly installed at the other end of the rotating rod 2.

Optionally, the outer surface of the cleaning strip is evenly fixedly embedded with multiple nozzles 1. One end of each nozzle 1 is fixedly installed with a connecting pipe 1, and the connecting pipes 1 are all in communication with multiple nozzles 1.

Preferred, the opposite side of the installation frame 2 is symmetrically fixed with two fixing blocks. Multiple fixing blocks are evenly divided into two groups, and both groups of fixing blocks are fixedly installed with cleaning bars 2 on the opposite side. Both groups of fixing blocks are fixedly installed with connecting pipes 2 on the opposite side, and one end of the two connecting pipes 2 extends to one side of two fixing blocks. Multiple nozzles 2 are evenly and equidistantly fixedly embedded on the outer surface of the two fixing blocks, and multiple nozzles 2 are evenly divided into two groups. One end of both groups of nozzles 2 is connected to the inside of the two connecting pipes 2.

Preferred, a bracket is fixedly installed on the other side of the installation frame 2, and a camera is fixedly installed on the side of the bracket close to the top.

Preferred, two fixed plates are symmetrically fixedly installed on one side of the support plate 1, and two water tanks are fixedly installed on the top of both fixed plates. Two pumps are installed inside the two water tanks, and the drain pipes of the two pumps are connected to the connecting pipe 1 and the two connecting pipes 2 respectively.

Compared with the prior art, the advantages and positive effects of the utility model are as follows:
1. By starting cylinder 1, it can extend and, in cooperation with U-shaped block 1, make support plate 1 rotate upward around the hinge and keep it horizontal. When it is necessary to adjust the orientation of solar panel 1 and solar panel 2, by starting motor 1, its output shaft can drive rotating rod 1 to rotate, synchronously driving rotating disk to rotate, thus driving support plate 2 and installation frame 2 to rotate, so that solar panel 1 and solar panel 2 can face the position where sunlight shines for a long time, thus improving the efficiency of converting solar energy into electric energy.

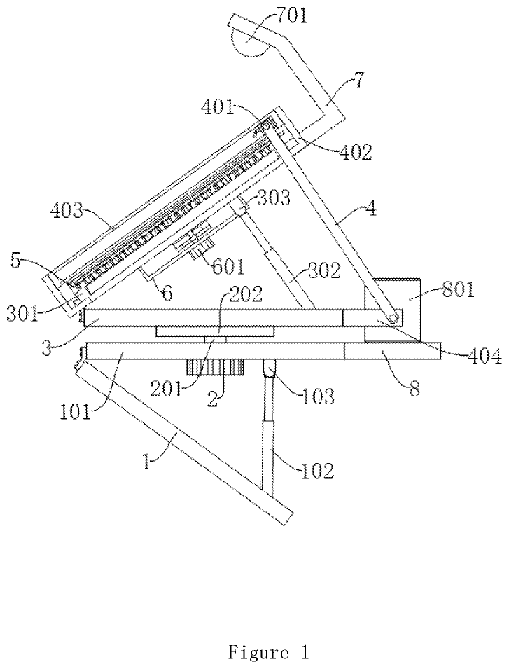

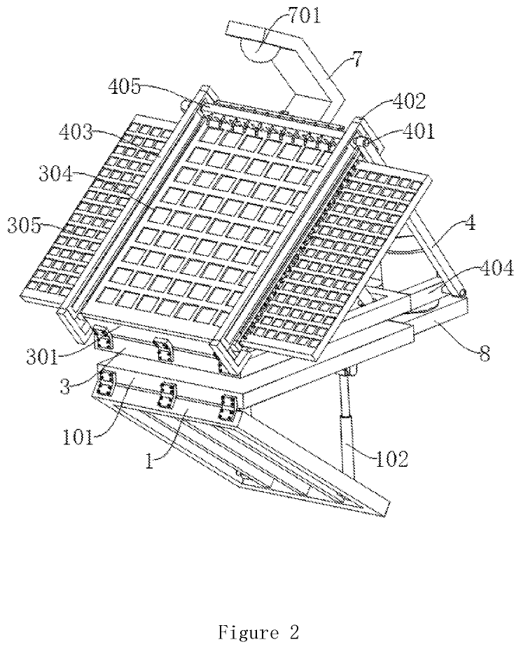

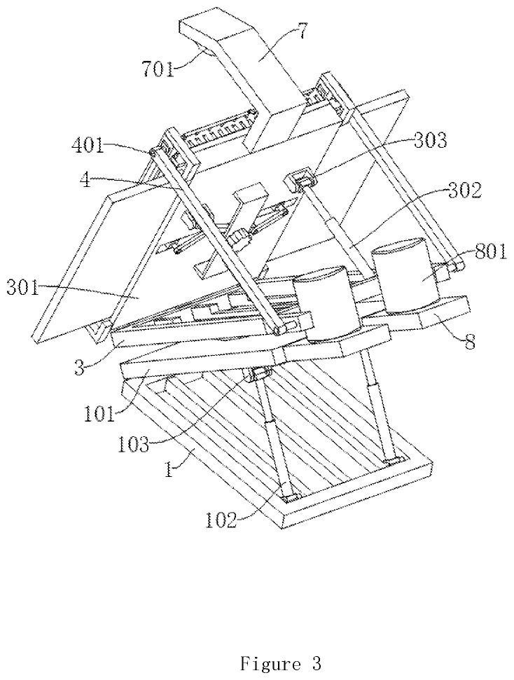

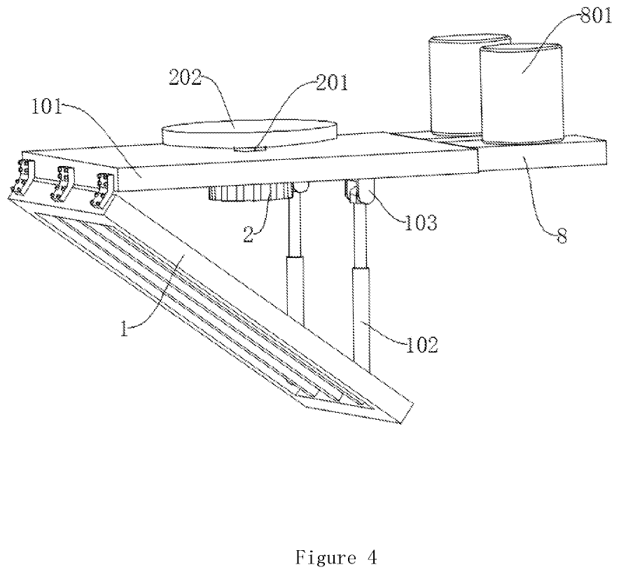

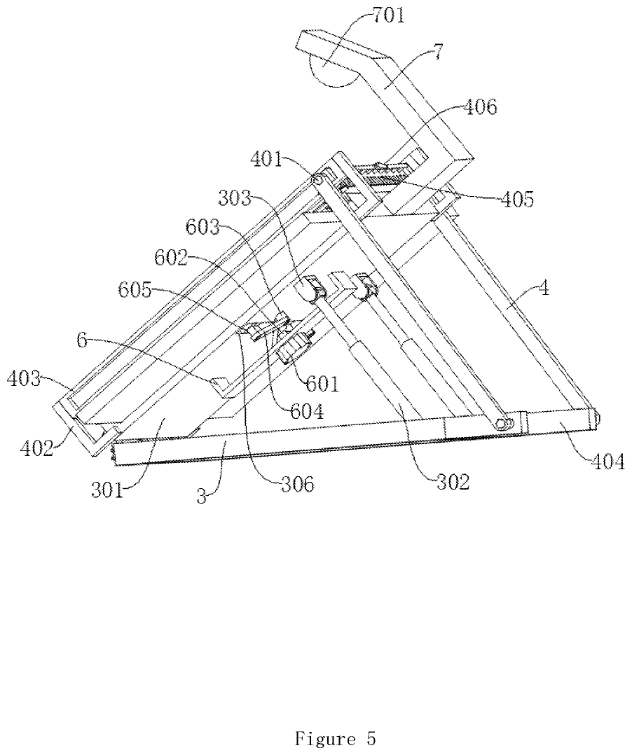

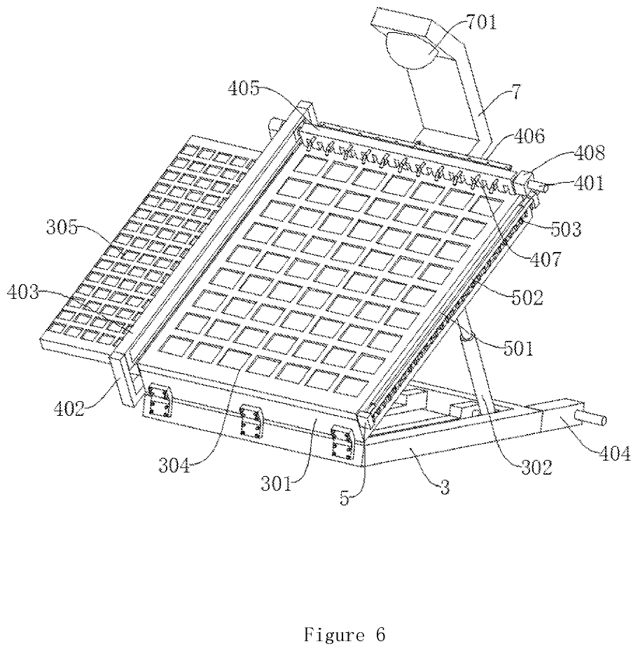

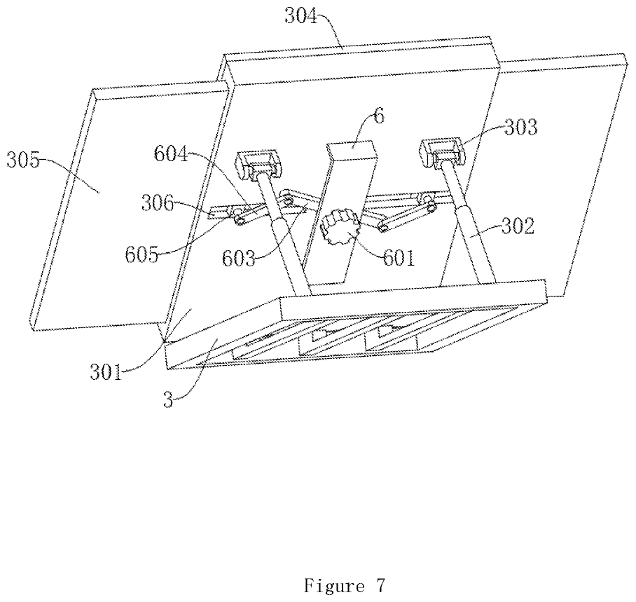

Embodiment 1, as shown in FIGS. 1-7, the present utility model provides a rotatable roof solar system, comprising: installation frame 1 and support plate 1. Installation frame 1 is connected to support plate 1 through a hinge, and further comprises:
Two cylinders 1, movably connected to the inner wall of installation frame 1 on opposite sides, and two U-shaped blocks 1 are symmetrically fixed at the bottom of support plate 1. One end of each of the two cylinders 1 is movably embedded in the opposite sides of the two arms of the two U-shaped blocks 1;
Connecting rod 1 is movably embedded in the center of support plate 1. The bottom of support plate 1 is fixed with motor 1, and the output end of motor 1 is fixedly installed on one end of connecting rod 1. The other end of connecting rod 1 is fixedly installed with rotating disc 202;
Support plate 2 is fixedly installed on the top of rotating disc 202, and one side of support plate 2 is connected to installation frame 2 through a hinge. Two solar panels 2 are symmetrically movably embedded in the interior of installation frame 2, and solar panel 1 is fixedly installed on the top of installation frame 2;
Two U-shaped blocks 2 are symmetrically fixed at the bottom of installation frame 2, and two cylinders 2 are movably embedded on the opposite side of support plate 2. One end of each of the two cylinders 2 is movably embedded in the opposite sides of the two arms of the two U-shaped blocks 2.

Furthermore, as shown in FIG. 1-7, on the other side of the installation frame 2-301, there are symmetrically fixed two L-shaped blocks 402. The multiple L-shaped blocks 402 are divided into two groups, and on the opposite side of the two groups of L-shaped blocks 402, there are fixed frames 403. The inner walls of the two frames 403 are equipped with movable blocks 408. On the opposite side of the two movable blocks 408, there are fixed round bars 401. The outer surface of the round bars 401 is fixed with cleaning strips 405. The two ends of the round bars 401 are equipped with connecting rods 4. On the other side of the support plate 2-3, there are symmetrically fixed two fixed bars 404. One end of the two connecting rods 4 is respectively movably fitted on the outer surface of the two fixed bars 404 of the support rod. By applying a thrust to the round bars 401 with the connecting rods 4, the round bars 401 can drive the movable blocks 408 to slide along the frames 403 to one side, and at the same time, can move the cleaning strip 405 to one side to clean the dust or bird droppings on the surface of the solar panel 1-304.

Furthermore, as shown in FIG. 1-7, there are two sliding slots 306 symmetrically opened at the bottom of the installation frame 2-301. The inner parts of the two sliding slots 306 are equipped with sliding blocks 605. One side of the two sliding blocks 605 is fixedly installed at the bottom of the solar panel 2-305 near one end. The bottom of the installation frame 2-301 is fixed with a U-shaped frame 6, and the center of the U-shaped frame 6 is equipped with a rotating rod 2-602. One end of the rotating rod 2-602 is movably fitted at the bottom of the installation frame 2-301. The outer surface of the installation frame 2-301 is fixed with a movable strip 1-603. The two ends of the movable strip 1-603 are movably connected to movable strips 2-604. One end of the two movable strips 2-604 is respectively movably connected to one side of the two sliding blocks 605. The bottom of the U-shaped frame 6 is fixed with a motor 2-601, and the output end of the motor 2-601 is fixedly installed at the other end of the rotating rod 2-602. By starting the motor 2-601, the output shaft can drive the rotating rod 2-602 to rotate, and at the same time, drive the movable strip 1-603 to rotate. Then, under the mutual coordination of the movable strip 1-603, the movable strip 2-604, and the sliding block 605, and the limiting effect of the sliding slots 306 on the sliding block 605, the movable strip 2-604 can push the sliding block 605 to move towards the middle along the sliding slots 306, and at the same time, drive the solar panel 2-305 to move towards the middle, so as to accommodate the solar panel 2-305 inside the installation frame 2-301.

Furthermore, as shown in FIG. 1-7, the outer surface of the cleaning strip 1-405 is evenly fixed with multiple nozzles 1-407. One end of the multiple nozzles 1-407 is fixedly installed with a connecting pipe 1-406. The connecting pipes 1-406 are connected to the multiple nozzles 1-407. With the setting of the connecting pipes 1-406 and the nozzles 1-407, it is convenient to clean the surface of the solar panel 1-304.

Furthermore, as shown in FIG. 1-7, the other side of the installation frame 2-301 is fixed with a bracket 7, and on one side of the bracket 7 near the top, a camera 701 is fixedly installed. With the setting of the camera 701, it is convenient to monitor the solar panel 1-304 and the solar panel 2-305, as well as the surroundings of the roof.

Furthermore, as shown in FIG. 1-7, on one side of the support plate 1-101, two fixed plates 8 are symmetrically fixedly installed. The tops of the two fixed plates 8 are fixedly installed with water tanks 801. The inner parts of the two water tanks 801 are equipped with water pumps. The drainage pipes of the two water pumps are connected to the connecting pipe 1-406 and the two connecting pipes 2-502, respectively

Working principle: When in use, first, the mounting bracket 1 is installed on the inclined surface of the roof. Then, by activating the cylinder 102, it extends and, with the cooperation of the U-shaped block 103, allows the support plate 101 to rotate upward around the hinge and remain in a horizontal position. When adjustment of the orientation of solar panel 1 304 and solar panel 2 305 is needed, the motor 2 is activated to drive the output shaft, which in turn rotates the connecting rod 201 and the rotating disc 202. This movement causes the support plate 2 3 and the mounting bracket 2 301 to rotate, aligning solar panel 1 304 and solar panel 2 305 with the position of sunlight, allowing them to be exposed to sunlight for a longer period of time and increasing the efficiency of solar energy conversion. The surface of solar panel 1 304 and solar panel 2 305 is monitored by camera 701. When the surface of solar panel 1 304 and solar panel 2 305 is covered with dust, bird droppings, or snow, the motor 2 601 is activated to drive the output shaft, which rotates the connecting rod 2 602 and the movable bar 1 603. Then, with the cooperation of movable bar 1 603, movable bar 2 604, and slider 605, and under the limitation of the groove 306 on slider 605, movable bar 2 604 pushes slider 605 towards the center, simultaneously moving solar panel 2 305 towards the inside of mounting bracket 2 301. During this movement, the cleaning bar 2 501 cleans the surface of solar panel 2 305. Additionally, by controlling one of the water pumps, water is pumped out from water tank 801 and sprayed onto the surface of solar panel 2 305 through connecting pipe 2 502 and nozzle 2 503 for cleaning. With the cooperation of cleaning bar 2 501, the surface of solar panel 2 305 is cleaned from dust, bird droppings, and other dirt. Then, the cylinder 2 302 is activated to retract, and with the cooperation of U-shaped block 2 303, mounting bracket 2 301 is pulled down, rotating downward around the hinge. This, in turn, applies a thrust to connecting rod 4 on circular rod 401, causing circular rod 401 to move the movable block 408 sideways along frame 403, simultaneously moving cleaning bar 1 405 to one side for cleaning the surface of solar panel 1 304. Another water pump is activated to pump water out from water tank 801 and sprayed onto the surface of solar panel 1 304 through connecting pipe 1 406 and nozzle 1 407 for rinsing. With the cooperation of cleaning bar 1 405, the surface of solar panel 1 304 is cleaned from dust, bird droppings, and other dirt. This process can be repeated multiple times for cleaning.

While a specific embodiment has been shown and described, many variations are possible. With time, additional features may be employed. The particular shape or configuration of the platform or the interior configuration may be changed to suit the system or equipment with which it is used.

Having described the invention in detail, those skilled in the art will appreciate that modifications may be made to the invention without departing from its spirit. Therefore, it is not intended that the scope of the invention be limited to the specific embodiment illustrated and described. Rather, it is intended that the scope of this invention be determined by the appended claims and their equivalents.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

1. A rotatable roof solar system, comprising an installation bracket (1) and a support plate (101), wherein the installation bracket (1) is connected to the support plate (101) through hinges. It further comprises:
Two cylinders (102) which are movably connected to the inner wall of the installation bracket (1) on opposite sides. The bottom of the support plate (101) is symmetrically fixed with two U-shaped blocks (103). One end of each of the two cylinders (102) is movably embedded in the opposite side of the two arms of the U-shaped block (103).
A rotating rod (201) which is movably embedded in the center of the support plate (101). The bottom of the support plate (101) is fixed with a motor (2), and the output end of the motor (2) is fixed on one end of the rotating rod (201). The other end of the rotating rod (201) is fixed with a rotating disk (202).
A support plate (3) which is fixed on the top of the rotating disk (202), and one side of the support plate (3) is connected with an installation bracket (301) through hinges. Two solar panels (305) are movably embedded symmetrically in the installation bracket (301). The top of the installation bracket (301) is fixed with a solar panel (304).
Two U-shaped blocks (303) which are symmetrically fixed on the bottom of the installation bracket (301), and two cylinders (302) are movably embedded on the opposite side of the support plate (3). One end of each of the two cylinders (302) is movably embedded in the opposite side of the two arms of the U-shaped block (303).

2. The rotatable roof solar system according to claim 1, further comprising:
Two L-shaped blocks (402) which are symmetrically fixed on the opposite side of the installation bracket (301). Multiple L-shaped blocks (402) are divided into two groups, and frames (403) are fixed on the opposite side of the two groups of L-shaped blocks (402). The inner wall of the two frames (403) is movably embedded with movable blocks (408), and circular rods (401) are fixedly embedded on the opposite side of the movable blocks (408). Cleaning strips (405) are fixedly set on the outer surface of the circular rods (401), and connecting rods (4) are movably set on both ends of the circular rods (401). Two fixed bars (404) are symmetrically fixed on the other side of the support plate (3), and one end of each of the connecting rods (4) is movably set on the outer surface of the support bars of the fixed bars (404).

3. The rotatable roof solar system according to claim 2, wherein two sliding grooves (306) are symmetrically provided on the bottom of the installation bracket (301), and sliding blocks (605) are movably embedded in the inner part of the two sliding grooves (306). One side of each of the sliding blocks (605) is fixedly installed at the bottom of the two solar panels (305) near one end. A U-shaped frame (6) is fixedly installed at the bottom of the installation bracket (301), and a rotating rod (602) is movably embedded at the center of the U-shaped frame (6). One end of the rotating rod (602) is movably embedded at the bottom of the installation bracket (301), and an active bar (603) is fixedly set on the outer surface of the installation bracket (301). Both ends of the active bar (603) are movably connected with active bars (604), and one end of each of the active bars (604) is movably connected to one side of the sliding blocks (605). A motor (601) is fixedly installed at the bottom of the U-shaped frame (6), and the output end of the motor (601) is fixed on the other end of the rotating rod (602).

4. The rotatable roof solar system according to claim 2, wherein the outer surface of the cleaning strips (405) is evenly fixed with multiple nozzles (407). One end of each of the multiple nozzles (407) is fixedly installed with a connecting pipe (406), and the connecting pipes (406) are all connected to the multiple nozzles (407).

5. The rotatable roof solar system according to claim 3, wherein two fixed blocks (5) are symmetrically fixed on the opposite side of the installation bracket (301). The multiple fixed blocks (5) are divided into two groups, and cleaning strips (501) are fixedly installed on the opposite side of the two groups of fixed blocks (5). Two connecting pipes (502) are fixedly installed on the opposite side of the two groups of fixed blocks (5), and one end of each of the two connecting pipes (502) extends to one side of the two fixed blocks (5). The outer surface of the two fixed blocks (5) is evenly fixed with multiple nozzles (503), and the multiple nozzles (503) are divided into two groups. One end of each of the two groups of nozzles (503) is connected to the interior of the two connecting pipes (502).

6. The rotatable roof solar system according to claim 5, wherein a bracket (7) is fixedly installed on the other side of the installation bracket (301), and a camera (701) is fixedly installed on the side of the bracket (7) near the top.

7. The rotatable roof solar system according to claim 5, wherein two fixed plates (8) are symmetrically fixed on one side of the support plate (101), and water tanks (801) are fixedly installed on the top of the two fixed plates (8). The interior of the two water tanks (801) is equipped with water pumps, and the drainage pipes of the two water pumps are connected to the connecting pipe (406) and the two connecting pipes (502) respectively.
